(19) United States
(12) Patent Application Publication
(10) Pub. No.: US 2010/0132365 A1
(43) Pub. Date: Jun. 3, 2010

(54) Start-Up Control For a Compact Lightweight Turbine

(76) Inventor: Gustavo Francisco Labala, Buenos Aires (AR)

Correspondence Address: NOTARO & MICHALOS P.C., 100 DUTCH HILL ROAD, SUITE 110, ORANGEBURG, NY, 10962-2100, US

(21) Appl. No.: 12/630,513

(22) Filed: Dec. 3, 2009

Related U.S. Application Data
(63) Continuation-in-part of application No. 11/404,265, filed on Apr. 13, 2006, now Pat. No. 7,644,572.
Application No. 11/404,265 is a continuation-in-part of application No. 10/827,943, filed on Apr. 20, 2004, now Pat. No. 7,065,954.

(51) Int. Cl. F02C 9/26; F02C 7/26

(52) U.S. Cl. 60/776; 60/39.08; 60/790

(57) ABSTRACT

In a turbo-engine system, oil is circulated by means of a positive-displacement pump directly driven by the output shaft. The pump output pressure is monitored to trigger fuel injection when the turbine reaches sufficient speed during the start-up sequence.

### CROSS-REFERENCE TO RELATED APPLICATIONS

The present application is a continuation-in-part of my U.S. patent application entitled “Compact Lightweight Turbine,” Ser. No. 11/404,265 filed on Apr. 13, 2006 as a continuation-in-part of my U.S. patent application Ser. No. 10/827,943 filed Apr. 20, 2004 and now U.S. Pat. No. 7,065,954 entitled “Compact Lightweight Turbine” and which issued on Jun. 27, 2006, the disclosures of which are all hereby incorporated herein by reference.

### FIELD OF THE INVENTION

The present invention is related to a compact, lightweight, efficient and durable turbo-engine able to deliver power to a shaft as well as thrust from the reaction of the exhaust gases and heat. One practical application of the present turbo-engine is for generating electricity. Another application is for propeller-driven aircrafts whether airplanes or helicopters, in marine uses for driving an under-water propeller, or any other application requiring delivery of power to a rotary shaft, whereby the balance of energy of the exhaust gases may be used for cogeneration or directly as heat.

More particularly, the present invention relates to a compact turbo-engine providing better performance, greater durability and lower maintenance for delivering mechanical work on a shaft and thrust by means of exhaust gases and/or heat, with powers below 600 HP in its preferred embodiment. This turbo-engine comprises an air compression stage, an annular combustion chamber preferably providing flame conduction and flame front stability control by means of jets generating vortices in the cold region (claimed in my co-pending application filed on Nov. ______, 2009 and entitled “Combustion Chamber for a Compact Lightweight Turbine”), an electrical fuel injection system providing power regulation, a high-speed, cantilevered shaft to which the compression and expansion stages are integrated, supported by a pair of bearings placed in the “cold” side, wherein the high-speed bearings are lubricated by an efficient oil distribution and direction system, a high-speed rotation transmission system, an internal oiling system, a compact gearbox system using planar gear-wheels for coupling the high-speed shaft to the power output shaft and the oil pump (including antivibration means claimed in my patented application Ser. No. 11/404,265) and a power-regulated and starting control system (according to the present invention), extractible splines conveying smooth transmission and reduced wear of the parts, and a starter control system.

### BACKGROUND OF THE INVENTION

To be cost efficient, terrestrial electrical generators under 1,000 HP use reciprocating engines as their power source. Reciprocating engines use up a lot of closed space which has to be adapted to tolerate heavy weights and medium- and low-frequency vibrations, high maintenance costs and a narrow range of fuels. Furthermore, these engines take a long time to warm up and get into condition for connecting to the power lines, which hinders their availability to swiftly respond to demand or else causes high maintenance costs when it is stopped for servicing to be carried out while still hot to reduce the outage time.

Light airplanes and helicopters needing power plants under 500 HP use internal-combustion engines. Compared to turbo-engines, these engines are heavier per unit of delivered power, highly complex because of the large quantity of moving parts they contain and require periodic specialized inspections.

Light one-to-four seating helicopters are particularly penalized because there is no alternative for them other than combustion engines. Therefore, their capabilities are severely restricted by the need to carry a heavy power plant, a significant weight compared to one or more passengers. Stresses and vibrations transmitted to the whole helicopter and to the passengers or the use of reciprocating engines further significant deter use of these helicopters.

The high market prices of both light airplanes and helicopters have made room for the use of turbines instead of combustion engines. A difference compared to combustion engines, wherein the different strokes of the ignition cycle are carried out reciprocating in cylinders (in pulses), is that turbines carry out their ignition-compression process continuously. Turbines comprise a compression stage for producing pressurized air, a combustion chamber into which the pressurized air is admitted together with fuel and an expansion stage producing power on a rotary shaft by means of a turbine integrated to the compressor. Part of the power generated by the turbine is used for driving the compressor and auxiliary systems (e.g. alternators, pumps, etc.), the balance is available as net power.

A favorable feature of turbines is their ability to generate a high density of mechanical energy per volume-unit compared to combustion engines of like power. On the other hand, an unfavorable feature is that turbo-engines lack massive oscillating or eccentric mechanisms, hence dynamic high-amplitude and low-frequency stresses are transmitted to the structure thereof.

A further competitive advantage of turbo-engines vis-a-vis combustion engines is the former's greater flexibility in the election of fuel. Combustion engines may only use aircraft petrol which is very volatile and explosive, leading therefore to safety concerns. On the other hand, turbo-engines may be fueled with aircraft kerosene (JP1), which is much less volatile and explosive, natural gas, diesel-oil or practically any kind of fossil or synthetic fuel producing less emission of polluting gases compared to combustion engines of like power. The possibility of using cheap fuel makes turbo-engines moreover more attractive for terrestrial or stationary uses for generation of electricity or delivering work to a shaft.

In addition, the balance of heat which is emitted as well as the high-temperature exhaust gases may be advantageously used, either for supplying a heating system or for recovery in a secondary cycle, leading to improved efficiency of the turbo-engine cycle. Furthermore, turbo-engines are less sensitive than combustion engines to loss of atmospheric pressure and low temperatures, as occurring at high flight altitudes. Aircraft turbines are firmly established in the high power segment, say above 600 HP.

The start-up sequence is defined as beginning when the starter-motor is turned on and continues until the turbine has gathered enough speed to operate in a permanent self-sustainable mode and the starter-motor is disengaged and the spark circuit disabled. It is the finite time it takes the speed of the turbo-engine, driven by the starter-motor, to gradually build up from zero up to a self-sustainable speed of normal turbine operation at which it may operate under its own power.

At some point during said finite time the fuel injectors are actuated to inject fuel into the combustion chamber. This point in time is determined by a predetermined speed the turbine has reached at which combustion may be initiated with the temporary aid of sparking plugs. Too early fuel injection of fuel would lead to an excessive rise of temperature inside the combustion chamber (because the turbine speed is below the predetermined point and there is not enough air intake to match the fuel flow) and, depending on how early fuel injection began, would produce a dangerous flame out from the exhaust duct of the turbo-engine or there would be no ignition at all leading to an undesirable accumulation of unspent fuel in the combustion chamber.

### Brief Review of the Prior Art

My Argentine patent publication AR 31,898A1 (application serial number P010105645), published on 8 Oct. 2003 and incorporated herein by reference, shows an annular combustion chamber and the path followed by gases inside there and a high-speed output shaft system including a system for lubricating the bearings of the main cantilever shaft thereof. One of the greater technical problems in designing an efficient, low-power turbine is that, due to physical operational principles, a reduction in the flow capacity and size thereof leads to having to increase the rotation speed of the compressor-turbine assembly, thereby significantly increasing mechanical stress on the moving parts materials. This conditions the life-term of the components and is in part associated with the wear of the moving parts.

A feature of conventional turbo-engine models is the use of speed (RPM) sensors for controlling the start-up sequence. The sequence consists in powering the starter system and, once a predetermined turning speed has been reached, the intake of fuel to the ignition injector is opened and the sparking plug enabled. The turbo machine increases its rotation speed even more until it surpasses the idling limit, after which the sparking plug is disabled and the supply of fuel to the running injectors is enabled. The use of a turning speed sensor (by proximity, optical or magnetic, inter alia), implies additional electronic components, assembly tolerances and strict maintenance check-ups in view of that the start-up sequence is of critical importance. The electronic components for signal processing and amplification are subjected to electro-magnetic noise and electrical failures, so that relying on such electronic means raises reliability concerns and, even more serious, is potentially physically hazardous for the human operator.

U.S. Pat. No. 4,211,070 (to Portmann) discloses the use of oil to (in addition to lubricate) drive a starter-motor. An external oil pump is required to initiate the turbine start-up sequence. The start-up sequence is complex in the sense that it uses a RPM detecting device (not based on oil pressure), an RPM comparator, a controller which operates opening and closing valves together with its corresponding electromechanical actuator and associated piping. U.S. Pat. No. 5,234,315 (to Ogihara et al) discloses an apparatus determining a shaft rotational speed by measuring the oil pressure to check shaft integrity. There is no suggestion of using the oil pressure measurement signal as a logical trip signal is a turbo-engine start-up sequence.

Another feature of conventional turbo-engine designs is the insertion of the oil pump inside the gearbox, where it is difficult to reach, or, as suggested in my above-mentioned AR patent publication AR 31,898 A1, externally coupled to the low-speed shaft by means of gears. Hence a drawback is the need for an additional coupling gear, resulting in more parts, weight and difficult disassembling, detrimental to compactness and simplicity.

Another feature of conventional turbo-engine models is their use of several mechanical devices of considerable complexity, such as valves and throttles for controlling the injection of the fuel into the combustion chamber. These devices have to be adjusted with extreme precision because of the narrow tolerances they are built around and are intensely affected by variations of atmospheric conditions. Since these mechanisms are made up of a number of parts, it is considerably expensive and difficult to include redundant systems to improve the reliability thereof and of the entire engine turbine in general. Furthermore, the operation of these mechanisms involves a complex ignition and control procedure during which the different ignition stages have to be manually enabled and disabled, opening the door to a new range of potential faults arising from human operational errors.

The operation of the turbine may be automated by means of mechanical, electronic or hybrid systems. Although this reduces the probability of human error, yet more systems are added to the already extremely complex systems of the turbine per se, adding further penalties in terms of cost and weight and introducing new fault sequences.

Because the auxiliary systems of the turbo-engines are complex, the power consumed by the auxiliary systems of high-power turbo-engines is similar to that of the systems of small turbo-engines. This curtails the design and implementation of low-power turbo-engines, as upper limits in the power consumption of auxiliary systems come into play in order for the operation of the turbine at low-power cruising speeds be self-sustainable.

In my above-mentioned AR patent publication AR 31,898 A1, the fuel is injected into the combustion chamber using two conventional electrical fuel pumps operating in parallel. Both pumps are able to deliver 100% of the required flow-rate, thereby providing full redundancy. The small increment in the power consumption as a result of the redundant injector pumps is more than offset by the greater reliability of the system. Both pumps are automatically turned on when the ignition key selects the ignition mode by means of electric clamping relays. The clamping requires an oil pressure signal for enabling the pumps. The operation status of the pumps can be checked by the turbo-engine operator, for proper decision taking in case of malfunction of either pump. The electric power supply for the injector pumps and for the electric starter motor is obtained from a low-voltage, high-load capacity battery. A precision valve in series with the injection pumps regulates the flow of fuel into the combustion chamber, thereby controlling flow according to the pressure drop in the control valve. In order to regulate the fuel injection rate in the state of minimum power so that the reaction is self-sustainable (regulated speed), a capillary tube shunt hydraulically short-circuits the inlet and outlet of the injection control valve so that the injector pumps always receive a small flow of fuel, even when the control valves are completely shut. The system is thus less sensitive to the fuel injection rate at low speeds in relation to the position of the control valve, enhancing the power control precision of the turbo-engine.

This prior art has the drawback that the control valve has to be operated via servomechanisms or else by means of the usual control cables, adding more devices with their attendant fault and maintenance rates.

In general, it can be said that the traditional aircraft turboshaft designs cannot be extrapolated down to the low-power range and still match the reliability, durability, efficiency and simplicity required in commercial aviation or avoid drawbacks in maintenance and wear for the generation of electricity or useful work on the ground. As explained hereinbefore, this is due to the complexity and technical problems that need to be overcome go up as the power and the size thereof go down. Proof of this is that available low-power turboshafts used for fixed or military installations are very complex, have limited lifespan, require a lot of maintenance and are pretty expensive considering the low power levels involved.

### SUMMARY OF THE INVENTION

An object of the invention is to provide a simple and inexpensive yet reliable method and means for controlling the start-up sequence in a turbo-engine. A particular object is a turbine start-up control method and means which may be started simply by the turn of a key for similar action) to proceed immediately thereafter until the turbine has gathered enough speed for turning the fuel injectors on. According to the invention, the fuel injectors are triggered automatically by a simple relay trip signal which is triggered by sensing the oil pressure when the turbine has reached the right speed. The start-up sequence continues a short time more and is terminated when the turbine has gathered enough speed to operate in a permanent self-sustainable mode.

The engine uses an on-board oil pump for circulating oil lubricating bearings, cogs and other moving engine parts, the pump driven by a rotary output shaft of the turbine. According to an aspect of the invention, a calibrated oil-pressure bulb is coupled to the pump or to the oil circulation system down-current from the pump, the bulb including a relay which switches to trigger fuel injection at a predetermined point in the start-up sequence when the oil pressure exceeds a set threshold indicating that the turbine has reached a sufficient speed of for fuel injection.

### BRIEF DESCRIPTION OF THE DRAWINGS

The above-stated and other novel features and aspects of this invention and how it may be reduced to practice may be understood better from the following detailed description of a preferred embodiment shown in the attached drawings, wherein:

FIG. 1 is a longitudinal cross-section schematical view of the compressor and expansion stages of a compact turbo-engine having an annular combustion chamber, showing the path followed by gases inside there.

FIG. 2 is a schematic longitudinal-section view of the coupling mechanism for transmitting rotational power from the high-speed shaft of the compressor-turbine assembly of FIG. 1 to the shift-down gearbox of the turbo-engine.

FIGS. 3A and 3B are partial perspective views taken from different angles of a turbo-engine showing the location of different mechanism parts such as the output stage including a step-down gearbox, an oil pump, a starter-motor and a control system according to a preferred embodiment of the present invention for use in light aircraft. Engine casing parts are removed in FIG. 3B to display mechanism parts inside.

FIG. 4 is a schematic cross-section of the coupling assembly between the low-speed power transmission shaft and the shift-down gearbox and the coupling to the oil pump.

FIG. 5 is a circuit schematic of the start-up circuit according to a preferred embodiment of the present invention.

FIG. 6 is a time graph representing the oil pressure build-up during the start-up method according to a preferred embodiment of the present invention.

### DETAILED DESCRIPTION OF A PREFERRED EMBODIMENT

### The Combustion Chamber System:

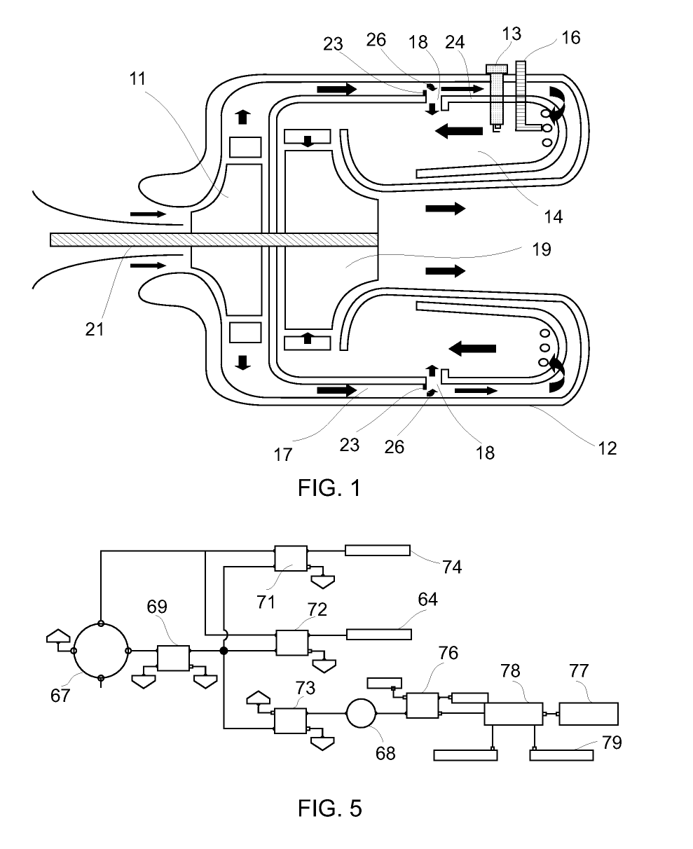

FIG. 1 illustrates a compact turbo-engine which may be used for the present invention, designed for use in light airplanes and helicopters. The compact turbo-engine includes an air-compression stage 11 comprising a 200-HP centrifugal compressor 11 of the radial-vane type, and an annular combustion chamber 12 including a cold peripheral region 17, a hot central region 14 and a fuel counter-flow injection system comprising redundant electrically-operated nozzles 16 for injecting fuel into the combustion chamber 12 against the gas (air) flow direction. Sparking plugs 13 are located in the hot region 14 for igniting the fuel and gas mixture during start-up.

The combustion chamber 12 is of a compact, toroidal shape so that the distance travelled by the air inside the chamber is longer than the major axis of the chamber 12. The combustion chamber 12 is made of Inconel 713 material, measures about 150 mm long by 260 mm external diameter and is provided with six counter-flow fuel injectors 16. The use of electric pumps or compressors in the fuel injection system provides for electronic flow control. Fuel intake into the combustion chamber is controlled both during start-up and normal running. Moving systems, such as cables, valves, servomechanisms, etc., are avoided, reducing periodic maintenance servicing to avoid drift, in view of that such systems are influenced by vibrations in the entire assembly and are new sources of malfunction. The system further provides good injection control precision over a broad range. In this manner, use of precision valves with high-quality fuel filters for achieving a like performance is avoided.

The turbine speed may also stabilized by means of control logic in terrestrial applications for production of electric power.

The forward part of this hot combustion region is called the flame front. The flame front is generated in the hot region 14 and expands towards the cold region 17. Flame conduction is by means of air jets 18 between the cold and hot regions 17-14.

The turbine further includes a turbine rotor 19 for extracting work and expansion, and a high-speed cantilever hollow shaft 21 with which the compression and expansion stages are integrated. The turbine shaft 21 is made of SS310 stainless steel, has an outer diameter of about 2 cm and its typical speed is 60,000 RPMs. The turbine rotor 19 and the centrifugal compressor 11 are mounted on one end of the high-speed cantilever shaft 21.

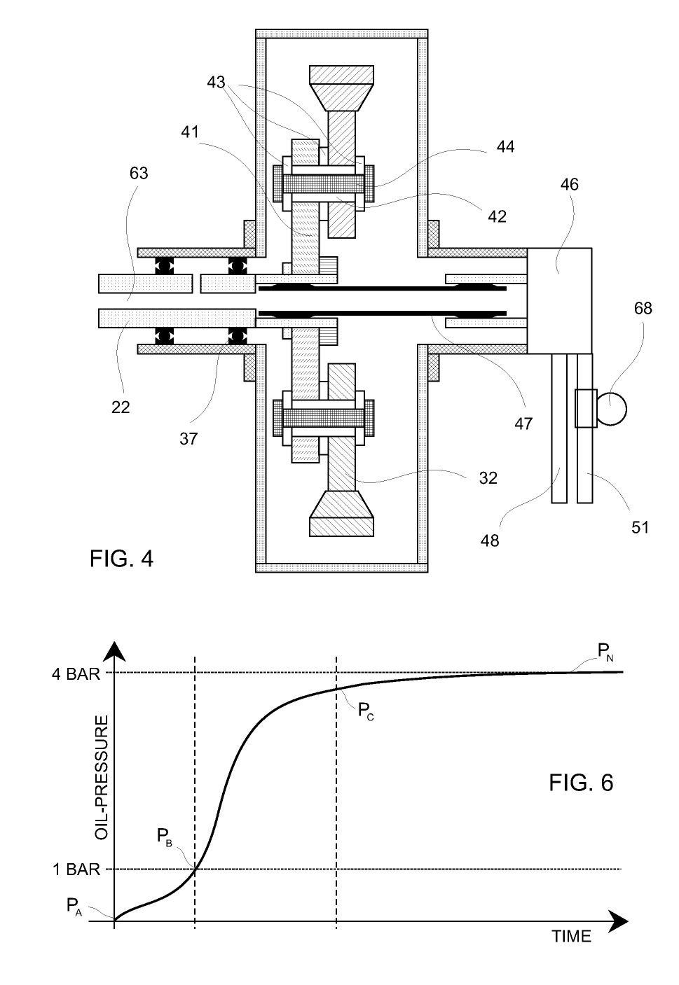

The dynamic system comprising the turbine 19, the combustion chamber 12 and the compressor 11 exclusively depends on the injection of fuel into the combustion chamber and the load applied to a power output shaft 22 (FIG. 4), so that the operator is left with just a single degree of freedom to control the turbine: i.e. regulating the fuel rate. This feature makes the operation of the turbo-engine extremely simple since the operator just regulates the fuel intake and the dynamic system self-adjusts to reach the speed corresponding to the operation status given by the relationship between the load and the fuel intake.

The combustion chamber further includes a semi-cylindrical deflector member 23 located on the wall 24 on the side of the cold region 17, up-current (relative to the gas flow direction in the inlet region 17) from the air jet orifices 18 communicating with the hot region of the combustion chamber, for generating vortices of the incoming secondary flow to the hot region 14 of the combustion chamber. Each deflector member 23 is slightly taller than the diameter of orifice 18 (which can be e.g. 2 mm in a 10 HP miniturbine up to about 40 mm in a 1,000 HP turbine. The deflector members 23 are of the same material as the outer wall of the chamber and are spot-welded thereto. The arrows in FIG. 1 illustrate how the gas in a portion 26 of the cold region is forced around the obstructions 23, forming the vortices in the flow through the orifices 18, known as the secondary flow in the combustion chamber. The intensity of the vortices depends on the flow-rate, so the greater the flow-rate the greater the effect.

The purpose of injecting a cold flow into the hot region of the combustion chamber is to cool the confinement walls 24 of the hot region, guide the outlet flow from the hot region and furthermore reduce the temperature of the outlet gases, which are a product of the combustion, prior to flowing towards the rotor 19. On the other hand, atmospheric contaminants produced by the combustion appear when the temperature of the combustion products is kept very high to produce association and dissociation of the molecules. By injecting the secondary flow into the hot region of the chamber, these effects are reduced, depending on the degree of mixing turbulence in this region.

By means of the deflector members 23, the flame front during normal running and during fast power transients is confined, thereby enabling a very good dynamic response to power variation, without the need of flame arresters to prevent the flame from reaching the more mechanically delicate region of the turbine or strongly limit the rates of acceleration and deceleration. Moreover, combustion is good and contaminant emission is low.

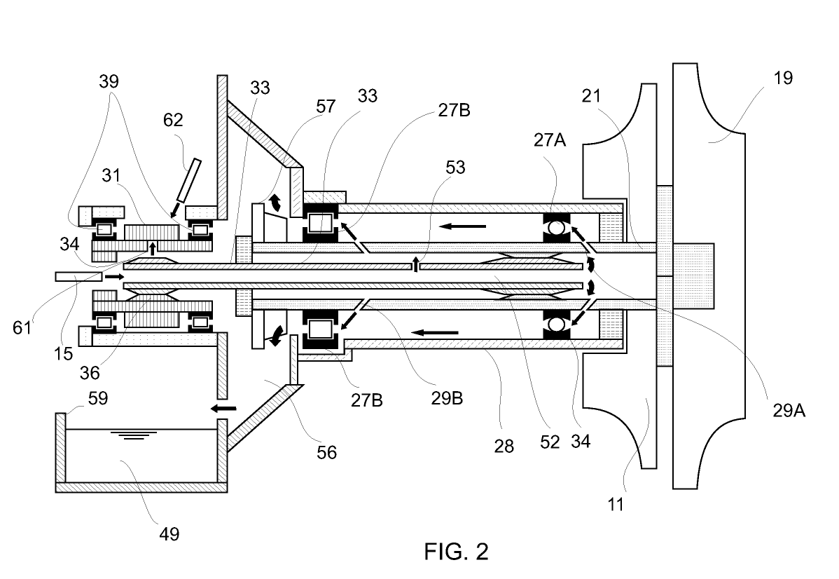

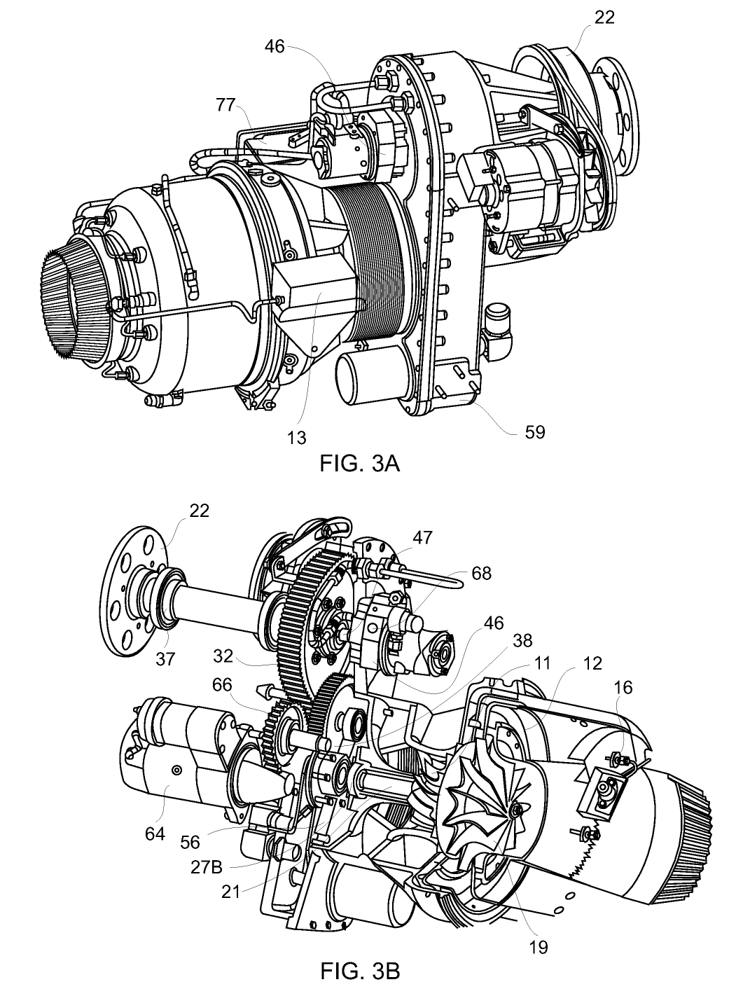

As illustrated in FIGS. 2 and 3B, the high-speed cantilever shaft 21 is supported on a pair of bearings 27A and 27B located in the “cold” side which are externally anchored by means of a jacket 28, and lubricated by means of oil distributed through the hollow inside of the shaft 21 and orifices 29A-29B in its wall. The jacket 28 has an outer diameter of about 45 mm and is about 15 cm long.

### The Loosely-Coupled Power Transmission System:

Referring to FIG. 2 in particular, transmission of power from the turbine-compressor assembly 11-19 to the gearbox 31-32 is accomplished by means of a removable hollow spline 33 coupled between the high-speed shaft 21 and the high-speed gear 31. The spline 33 is made of SS310 stainless steel, has an outer diameter of about 15 mm and is also about 15 cm long most of which is housed inside the hollow shaft 21.

This spline 33 is fluted 34 at the both ends, providing a loose pivotable coupling to both the turbine shaft 21 and the high-speed gear 31. The high-speed gear 31 is hollow thus defining a central cavity having longitudinal grooves 36 for engaging corresponding fluting teeth 34 provided also on this end of the spline 33. At the other end of the spline 33, the fluting 34 on the spline portion housed inside the cantilevered shaft 21 likewise loosely couples these members 21, 33 allowing for pivoting about a small angle. The fluting 34 at either end of the embodied spline 33 is designed to tolerate eccentricities up to between ½-1 mm.

Referring also briefly to FIG. 4, kinetic rotational power produced by the turbine 19 on its high-speed shaft 21 is outputted on a low-speed shaft 22 by means of a compact step-down gearbox 31-38-32. The output shaft 22 is mounted on lubricated bearings 37 and is also made of SS310 stainless steel, has an outer diameter of about 5 cm, its typical speed is 2,500 RPMs and supplies mechanical power to typical aircraft mechanisms such as propellers, alternators, accessories and the like (not illustrated). The gearbox 31-38-32 includes parallel planar or small-angle gearwheels which simplifies assembly and lubrication thereof. Speed step-down is carried out by means of a high-speed gearwheel 31 (FIG. 2), an intermediate reduction gearwheel 38 and a low-speed gearwheel 32 made of Alloy 4140 Steel. The high-speed gearwheel 31 is axially-rigidly mounted on a tandem of bearings 39. The low-speed gear 32 is approximately 20 cm in diameter and 4 cm across. The overall transmission ratio is 24:1.

In addition, since the couplings are furthermore bathed in oil, vibrations are decoupled on both sides of the coupling, thereby lowering stresses on the bearings 27A-27B, 39 and 37. The oil film that is formed on the cog surfaces has the advantage of further decoupling vibrations of the turbo-engine assembly from the step-down gearbox which are at considerably different frequencies and intensities. Very good gear alignment may be achieved to extend the lifespan thereof. All these features reduce tolerance severity in the assembly of both subsystems and, therefore, may be used in installations which are less complex than current installations.

The vibration decoupling device avoids rigid metal-metal contact through the power transmission path. The device is implemented by inserting resilience materials between the low-speed gear 32 and the power output shaft 22. There is a wide range of commercially available materials that can be used for this application. The strength and the elasticity of the material will depend on a particular design of gearbox, its operating temperature, chemical environment, vibration level and the maximum shaft torque. In this gearbox embodiment for the power turbine application, Teflon™ is selected as a resilience material of bushing means.

To prevent wear and decouple vibrations between the load connected to the power output shaft 22 and the gearbox, the embodiment represented in FIG. 4 uses a coupling made of a resistant and resilient material. The coupling mechanism between the power output shaft 22 and the planar gear 32 comprises a disk 41 made of SS310 stainless steel mounted to the shaft. The disk 41 is provided with orifices in which a resilient bushing having a sleeve 42, Teflon™ separator washers 43, between the coupling disk 41 and the gear 32, and steel bolts 44 are assembled. In the preferred embodiment illustrated in FIG. 4, six standard DIN 931-M8 bolts 44 sheathed in Teflon™ sleeves 42 are used for affixing the is low-speed gear 32 to the power output shaft 22, allowing proper power transmission and damping vibration there-between.

This coupling is similar to that between the collars of tubes, for instance, except that the steel bolts 44 are sheathed in a sleeve 42, in addition to the washers 43 arranged bolt heads, the disk 41, the gear 32 and the nuts for tightening the bolts 44. In this way, a loose (i.e. not rigid) yet stable coupling mechanism is achieved with no metal-to-metal contact between the coupling disk 41 affixed to the transmission of power shaft 22 and the gear 32. The use of bushings and washers of elastic materials blocks high frequencies from the power shaft 22 which would otherwise affect the useful lifespan of the bearings 37 and the housings thereof. In this way low-cost alloys may be used for the housings. The resulting amount of vibration de-coupling is similar to that obtained conventionally with rubber disks which absorb angular vibrations, thereby extending gearbox lifespan.

### The Lubrication System:

The moving parts of turbo-engine, including the bearings 27A and 27B, are lubricated using commercial turbine oil. The turbo-engine of the present invention is able to operate at speeds of up to 70,000 RPM on the high-speed shaft, with an extended life-term of the high-speed shaft bearings 27A-27B by means of the oiling system shown in FIGS. 2 and 4. In addition, the physical arrangement of the annular combustion chamber, compressor and turbine together with the arrangement of the pair of bearings 27A-27B in the cold region of the cantilever compressor-turbine assembly allows the oil operation conditions on the bearings 27A-27B to be relaxed.

As shown in FIG. 4, the lubrication system uses a positive-displacement external pump 46 which is mounted to the low-speed power output shaft 22 to derive mechanical power therefrom for oiling components of the turbine 19 in a manner described in more detail hereinafter. The pump 46 is mounted to the low-speed power output shaft 22 by means of a removable spline 47. This simplifies maintenance thereof since it is easy to dismantle the pump from the gearbox. This spline 47 is made of SS310 stainless steel and is approximately 15 mm de diameter and 10 cm long.

A pipe 48 draws oil from a reservoir 49 together with air into the pump 46 and the resulting mixture is pumped out through an outlet pipe 51. Referring briefly to FIG. 3A, the pipe 51 connects the pump outlet to the high-speed shaft 21. As shown in FIG. 2, oil from the pipe 51 enters through one end of the bore 52 longitudinally traversing the hollow spline 33 and is injected through orifices 53 and out of the distant end of the spline bore 52 into the shaft 21 where it is directed towards the ball-raceways of the bearings 27A-27B. There are at least six orifices 29A-29B evenly distributed around the shaft circumference, each sub-millimeter in diameter and slanted at an angle. In an alternative embodiment, there are no orifices 29B near the middle of the shaft 21 but only near the end of the shaft away from the oil supply pipe 51, so that both bearings 27A-27B are lubricated in series with the same lubricating jet passing through orifices 29A.

The spline 33 has a slightly frustoconical bore 52 tapering outwards at an angle of 1° towards the distant end thereof for assisting in conducting the lubrication mixture therealong at high shaft speeds.

The oil is drawn out of the bearings 27A-27B and driven towards a discharge chamber 56 by a radial-vane type blower 57. The blower 57 is driven by the high-speed shaft 21 and essentially enables a large amount of lubricant to be removed from the bearings 27A-27B, contributing to the formation of the droplet spray and to removal of heat from the bearings 27A-27B via the removed oil-and-air mixture. The blower 57 also prevents the bearings 27A-27B from becoming inundated in oil which would otherwise generate significant braking and frictional heating at such high speeds.

The lubricant present in the discharge chamber 56 is drained towards a lower reservoir 49 of the step-down gearbox, where it cools by mixing with the residue oil stored therein. To keep the oil temperature below safety limits, say 85° C., the reservoir 49 holds at least 2 liters of oil in this embodiment.

In view of that the oil is scarcely heated up during passage through the bearings 27A-27B at high speed using this lubrication system, no coolers are generally needed to keep the temperature from exceeding the range in which its properties are not degraded. When generally operating at less than full power or for intermittent periods of some tens of minutes, the outer surface of the gearbox casing 59 is sufficient for cooling the oil stored in the lower reservoir 49 of the gearbox through heat-exchange with the surrounding environment and conduction through the outer casing 59 of the step-down gearbox and external convection, assisted by the inflow of air under forced convection to the compressor 11.

However, in a poor heat-removing environment, an external conventional radiator may be inserted in the oil circuit through additional piping downcurrent from the oil pump. In order to assure continuous operability at full 150-HP power regardless of weather conditions, an oil radiator de 15 cm (length)×30 cm (height)×5 cm (width), typically available from motorcycle dealers, is adequate for keeping the oil temperature below 85° C. In this case (auxiliary radiator) the total oil volume (i.e. sump plus circulating) should be increased by liter.

All this contributes to a simple, small and lightweight system. Another by no means minor consequence for the turbo-engine is that friction is low and, therefore, very little mechanical energy is converted into heat and wasted so that machine efficiency is increased.

The implementation of such a system can be accomplished by modification and adaptation of commercially available high-speed bearings and stainless-steel pipes. Sizing and materials are dependant on a particular design of the engine. Stainless-steel pipes (adequate for high pressure and high temperature lubricants) are available in wide range of variety in diameter and thickness. High-speed bearings are also commercially available in wide range of inner diameters, outer diameters and materials (plastic, ceramic and metal alloys). The right choice of components depends on a particular design parameters of the engine. Mainly, moment of inertia and torque requirements determine shaft diameter which, in turn, determines the inner diameter of the bearings.

For the present embodiment, the preferred materials of the bearings 27A-27B are ceramic or metal alloys for ease of machineability and further modification and adaptability to this high speed lubrication system. In the current embodiment, a stainless steel tube having an inner diameter of 6 mm is used. For the bearing system 27A-27B of the high speed shaft 21, two standard cylindrical roller-bearings type DIN5412 having an inner diameter of about 2 centimeters are found to satisfy the mechanical requirements of the present turbine embodiment.

The pump 46 draws in cooled oil through a duct 48 from the reservoir 49, passing through a filter on the way, and distributes the oil towards the central cavity of the high-speed spline 33 through the ducts 29A-29B and towards the bearings 27A-27B of the power output shaft 21 as described hereinbefore. The high-speed gearwheel 31 is oiled through orifices 61 passing through the base of the cogs thereof from the central cavity, from where the oil flow is driven by centrifugal force from the centre, and by injection from a duct 62 coming from the discharge outlet of the pump 46 in the oil circulation system, as indicated by the arrows. Turning again to FIG. 4, oil is also directed towards the bearings 37 of the power output shaft 22 through a central cavity 63 in the latter shaft and to the gears 31-32 by means of distribution ducts.

### The Start-Up System:

The turbo-engine start-up sequence uses a battery-operated electric starter-motor 64, such as a 3 kW, 12 V, Prestolite M93R starter, coupled to the low-speed gearwheel 32 by another gearwheel 66 also made of Alloy 4140 steel. The motor 64 may be started by the turn of an ignition key switch 67 schematically shown in FIG. 5 to initiate the start-up sequence to begin to rotate the turbine 19 via the low-speed gearwheel 32 and the intermediate gearwheel 38 until the turbine 19 reaches a set speed.

With a view of reducing the quantity of components and maintenance check-ups, the sensing of the rotation speed of the turboshaft for activating the fuel injectors 16 during the start-up sequence is carried out by monitoring the oil pressure at the outlet of the positive-displacement oil pump 46 used for distributing oil to lubricate the moving parts of the turbo-engine, as explained hereinbefore. The pressure in this kind of pump 46 is proportional to the rotation speed of its driven shaft. Since the pump 46 is directly coupled by the short spline 47 to the low-speed shaft 22 and, via the step-down gearbox to the shaft 21, of the compressor-turbine assembly, a bulb 68 calibrated at a pre-determined pressure, i.e. RPMs, may be used for controlling the start-up sequence. This system is moreover robust and resistant to vibrations, and dramatically reduces maintenance requirements and assembly tolerances of the complex turning-speed measurement systems like, e.g. proximity, magnetic or optic sensors or the like. As used herein, the terminology “directly coupled” means that all intervening mechanism are of substantially mechanical nature.

One of the advantages of this start-up sequence is that it eliminates virtually all the failures based on human factors. The operator need only turn an ignition switch 67 and pay attention to the temperature gauge (which can be easily automated). When the operator turns the start key 67, the starter motor 64 turns, the convention electric spark generation circuit 13 is enabled and the oil pump 46 begins to operate. Speed and oil pressure gradually increase until the oil pressure bulb 68 goes out (trips). At this stage, the fuel pump 77 supplying the injectors 16 is switched on and the engine speed, oil pressure and exhaust temperature continue to gradually increase until the start-up sequence is finished, the starter-motor 64 is disengaged and the spark circuit 13 disabled. The engine speed and the exhaust temperature stabilize.

FIG. 5 shows an electrical circuit for accomplishing the foregoing. The pilot or operator turns the ignition key 67 from the “OFF” position to the ignition “ON” position, closing a master relay 69 to ground one terminal of each of the coils of two slave relays 71 and 72 and also close a third slave relay 73 that biases the bulb 68 to the battery voltage +V (e.g. 12 Vdc). The pilot/operator then immediately turns the ignition key 67 to the start position “ST” thereby closing both slave relays 71 and 72 to turn the spark generator 74 and the starter-motor 64 on.

Driven by the starter-motor 64, the turbo-engine begins to turn also driving the oil pump 46 engaged therewith causing the oil pressure to rise up from P_{A}=0 in the graph of FIG. 6, until the it reaches a preset point P_{B} which trips the bulb 68 which closes a relay 76 to trigger the fuel pump 77. At this point, fuel combustion in the chamber 12 assists in increasing the turbine speed and the pressure rises at a faster rate. At a point P_{C} near the normal operating pressure P_{N} the pilot/operator releases the ignition key 67 back to the “ON” position so that the spark generator 74 and the starter-motor 64 are disabled as the start sequence terminates and the turbine enters its normal operation state, during which the relays 69 and 73 keep the bulb 68 biased. The time scale in the graph of FIG. 6 generally varies according to ambient temperature (since oil viscosity is temperature-dependent) and battery charge; typically the time it takes the sequence to go from P_{A}=0 to P_{C} in FIG. 6 varies between 10 and 20 seconds.

A programmable electronic control circuit 78 includes conventional PID logic to inhibit fuel injection if a temperature sensor 79 indicates a heat problem. The above-described bulb arrangement provides the further advantage of shutting down fuel injection by opening relay 76 in the event of an oil-pressure failure during normal operation, i.e. even long after the start sequence has terminated, or another monitored event such as dangerous oil-pressure drops or excessive engine vibrations.

In the preferred embodiment, the spark generator 74 is enabled a finite time (typically less than a second) before the fuel pump 77 is turned on to compensate the time it typically takes sparking to occur at the plugs 13 once the generator 74 is turned on. If the spark generator 74 were enabled by the oil bulb 68 simultaneously with the fuel pump 77, fuel injection could precede sparking-plug 13 operation in the chamber 12 wetting the plugs 13 with the result that sparking is hindered. Since the power consumption of the sparking-plug 13 is low in comparison to the starter motor 64, there is no penalty for enabling the sparking-plugs 13 at the beginning of the start sequence in order to make sure the turbo-engine starts successfully.

The turbine start-up sequence thus is based on a simple electric circuit and fuel injection is triggered by only one on-off signal. The signal is generated by the calibrated oil pressure sensor 68 and assures lubricant delivery (for safe running of the turbine 19) and suitable engine RPMs to reach the idle-condition once the fuel injection is enabled.

Another of the advantages of the use of a bulb 68 in the start-up sequence is its simplicity and toughness. The bulb is a straight-forward electromechanical component and practically immune to all kinds of electrical faults and noise, thereby improving reliability and, more importantly, safety for the pilot or human operator of the equipment.

Current implementation is accomplished by commercially available automobile starter-motor 64 and the oil-pressure sensor 68 is also commercially available. The Prestolite M93 Starter mentioned hereinbefore, which is preferred in the present embodiment, is widely available for different motor vehicle models.

I claim:

1. A method for controlling the start-up sequence of a turbo-engine, said turbo-engine including:
a rotary shaft and other moving parts,
a combustion chamber for driving said rotary shaft and adapted for fuel to be injected therein,
an oil circulation system for lubricating said moving parts, said system including an oil pump directly coupled to said rotary shaft for circulating the oil through said system under pressure,
starter means for driving rotation of said rotary shaft during said start-up sequence and
means for turning said starter means on upon initiation of said start-up sequence;
said method comprising:
monitoring said oil circulation pressure,
deriving a logical signal indicative of whether said oil pressure is above or below a predetermined threshold and
using said derived logical signal to trigger fuel injection into said combustion chamber during said start-up sequence in response to said logical signal exceeding the predetermined threshold.

2. The method of claim 1, wherein said logical signal is an electrical signal.

3. The method of claim 1, wherein said predetermined oil-pressure threshold is greater than zero and less than a normal oil-circulation pressure after said start-up sequence is terminated.

4. A turbo-engine including:
a rotary shaft and other moving parts,
an oil circulation system for lubricating said moving parts, said system including an oil pump coupled to said rotary shaft for circulating the oil through said system under pressure,
starter means for driving rotation of said rotary shaft during said start-up sequence,
means for turning said starter means on upon initiation of said start-up sequence,
a switch arranged to trip during said start-up sequence in response to the pressure of the oil in said system increasing above a predetermined threshold and
means responsive to said switch tripping to trigger the fuel injection system on during said start-up sequence.

5. The turbo-engine of claim 4, wherein said switch comprises a calibrated bulb coupled to said oil pump.

6. The turbo-engine of claim 5, wherein said calibrated bulb coupled to the outlet of the oil pump.

7. The turbo-engine of claim 4, wherein said oil pump is a positive-displacement pump directly coupled to said rotary shaft.

8. The turbo-engine of claim 4, wherein said oil pump is coupled to said rotary shaft through a gearbox mechanism.

9. In a turbo-engine including a combustion chamber and means for injecting fuel into said combustion chamber a finite time after said turbo-engine is started, the use of means monitoring oil pressure in the turbo-engine to initiate fuel injection in response to the oil reaching a preset pressure in the turbo engine.
